(19) United States
(12) Patent Application Publication
(10) Pub. No.: US 2026/0145423 A1
(43) Pub. Date: May 28, 2026

(54) IMAGE FORMING APPARATUS CAPABLE OF PREVENTING DRIVE VOLTAGE SET ON BASIS OF TEMPERATURE OF INK FROM EXCEEDING OUTPUTTABLE RANGE OF POWER SUPPLY AND SETTING METHOD

(71) Applicant: KYOCERA Document Solutions Inc., Osaka (JP)

(72) Inventor: Masayuki Miyake, Osaka (JP)

(21) Appl. No.: 19/385,713

(22) Filed: Nov. 11, 2025

(30) Foreign Application Priority Data
Nov. 26, 2024 (JP) 2024-205205

(51) Int. Cl. B41J 2/045

(52) U.S. Cl. CPC B41J 2/0457; B41J 2/04563; B41J 2/04581

(57) ABSTRACT

An image forming apparatus includes an ejection portion, a first power supply, a first setting processing portion, and a third setting processing portion. The ejection portion ejects ink from a nozzle in response to an input of a drive voltage. The first power supply outputs the drive voltage within the outputtable range corresponding to an input voltage in response to the input of the input voltage. The first setting processing portion sets the drive voltage within a settable range set in advance on the basis of the temperature of the ink. In a case where any one of an upper limit value and a lower limit value of the settable range is not included in the outputtable range, the third setting processing portion sets the input voltage on the basis of the upper limit value and the lower limit value.

### INCORPORATION BY REFERENCE

This application is based upon and claims the benefit of priority from the corresponding Japanese Patent Application No. 2024-205205 filed on Nov. 26, 2024, the entire contents of which are incorporated herein by reference.

### BACKGROUND

This disclosure relates to an image forming apparatus and a setting method.

An image forming apparatus including an ejection portion that ejects ink from a nozzle in response to the input of a drive voltage has been known.

In addition, the image forming apparatus that adjusts the drive voltage on the basis of the temperature of the ink while an image formation process of forming an image on a sheet is in execution has been known. For example, the image forming apparatus of this type includes a power supply, a sensing processing portion, and a setting processing portion. The power supply outputs the drive voltage within the outputtable range corresponding to an input voltage to the ejection portion in response to the input of the input voltage. The sensing processing portion senses the temperature of the ink while the image formation process is in execution. The setting processing portion sets the drive voltage on the basis of a result of sensing by the sensing processing portion. The settable range of the drive voltage by the setting processing portion is set as appropriate depending on a change in the ink ejection performance of the ejection portion caused by the aged deterioration or the like of a recording head including the ejection portion.

### SUMMARY

An image forming apparatus according to an aspect of this disclosure includes an ejection portion, a first power supply, a sensing processing portion, a first setting processing portion, a second setting processing portion, an acquisition processing portion, and a third setting processing portion. The ejection portion ejects ink from a nozzle in response to an input of a drive voltage set in advance. The first power supply outputs the drive voltage within an outputtable range to the ejection portion in response to an input of an input voltage set in advance. The outputtable range corresponds to the input voltage. The sensing processing portion senses temperature of the ink while an image formation process of forming an image on a sheet using the ejection portion is in execution. The first setting processing portion sets the drive voltage on the basis of a result of sensing by the sensing processing portion. The second setting processing portion sets a settable range of the drive voltage by the first setting processing portion in response to a setting operation defined in advance. The acquisition processing portion acquires an upper limit value and a lower limit value of the settable range at a specific timing outside an execution period of the image formation process. The third setting processing portion sets the input voltage on the basis of the upper limit value and the lower limit value acquired by the acquisition processing portion in a case where any one of the upper limit value and the lower limit value is not included in the outputtable range.

A setting method according to another aspect of this disclosure is executed by an image forming apparatus including an ejection portion that ejects ink from a nozzle in response to an input of a drive voltage set in advance, and a first power supply that outputs the drive voltage within an outputtable range to the ejection portion in response to an input of an input voltage set in advance. The outputtable range corresponds to the input voltage. The setting method includes a sensing step, a first setting step, a second setting step, an acquisition step, and a third setting step. In the sensing step, temperature of the ink is sensed while an image formation process of forming an image on a sheet using the ejection portion is in execution. In the first setting step, the drive voltage is set on the basis of a result of sensing by the sensing step. In the second setting step, a settable range of the drive voltage by the first setting step is set in response to a setting operation defined in advance. In the acquisition step, an upper limit value and a lower limit value of the settable range are acquired at a specific timing outside an execution period of the image formation process. In the third setting step, the input voltage is set on the basis of the upper limit value and the lower limit value acquired by the acquisition step in a case where any one of the upper limit value and the lower limit value is not included in the outputtable range.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image forming apparatus according to an embodiment of this disclosure.

FIG. 2 is a diagram showing a configuration of an image forming portion of the image forming apparatus according to the embodiment of this disclosure.

FIG. 3 is a diagram showing a configuration of a recording head of the image forming apparatus according to the embodiment of this disclosure.

FIG. 4 is a diagram showing an example of an outputtable range of a first power supply of the image forming apparatus according to the embodiment of this disclosure.

FIG. 5 is a flowchart showing an example of a drive voltage setting process that is executed by the image forming apparatus according to the embodiment of this disclosure.

FIG. 6 is a flowchart showing an example of an input voltage setting process that is executed by the image forming apparatus according to the embodiment of this disclosure.

### DETAILED DESCRIPTION

Hereinafter, an embodiment of this disclosure will be described with reference to the accompanying drawings. It is noted that the following embodiment is a specific example of this disclosure and does not limit the technical scope of this disclosure.

### Configuration of Image Forming Apparatus 100

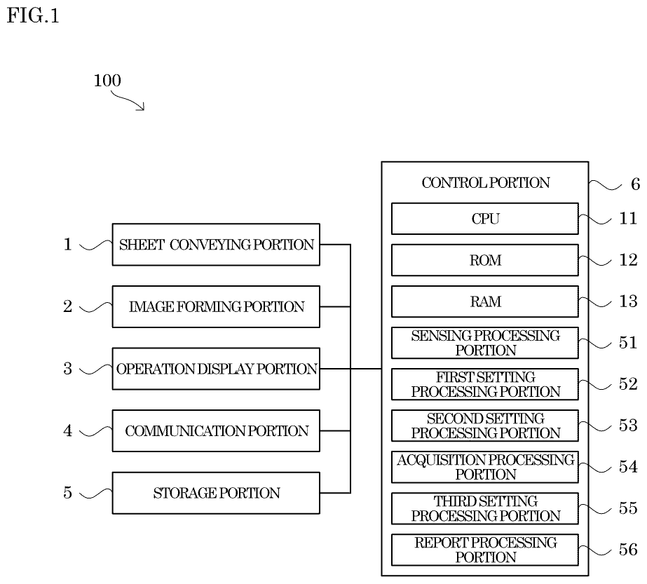

First, the configuration of an image forming apparatus 100 according to the embodiment of this disclosure will be described with reference to FIG. 1.

The image forming apparatus 100 is a printer capable of forming an image on a sheet in an inkjet method. The image forming apparatus 100 is a so-called line-printing image forming apparatus. It is noted that this disclosure is applicable to an image forming apparatus such as a printer, a facsimile apparatus, a copier, and a multifunction peripheral capable of forming an image on a medium such as a sheet in an inkjet method.

As shown in FIG. 1, the image forming apparatus 100 includes a sheet conveying portion 1, an image forming portion 2, an operation display portion 3, a communication portion 4, a storage portion 5, and a control portion 6.

The sheet conveying portion 1 conveys a sheet on which an image is formed by the image forming portion 2. The sheet conveying portion 1 includes a sheet feed cassette and a plurality of conveying rollers.

The image forming portion 2 forms an ink image on a sheet conveyed by the sheet conveying portion 1.

The operation display portion 3 is a user interface of the image forming apparatus 100. The operation display portion 3 includes a display portion and an operation portion. The display portion displays various kinds of information in response to a control instruction from the control portion 6. For example, the display portion is a liquid-crystal display. The operation portion inputs various kinds of information to the control portion 6 in response to an operation of a user. For example, the operation portion is a touch panel.

The communication portion 4 is a communication interface that executes data communication with an external information processing apparatus such as a personal computer in a wired or wireless manner.

The storage portion 5 is a non-volatile storage device. For example, the storage portion 5 is a storage device including a non-volatile memory such as a flash memory, a solid state drive (SSD), a hard disk drive (HDD), and the like.

The control portion 6 integrally controls the image forming apparatus 100. As shown in FIG. 1, the control portion 6 includes a CPU 11, a ROM 12, and a RAM 13. The CPU 11 is a processor that executes various calculation processes. The ROM 12 is a non-volatile storage device that stores, in advance, information about a control program or the like for causing the CPU 11 to execute various processes. The RAM 13 is a volatile or non-volatile storage device that is used as a temporary storage memory (work area) for various processes which are executed by the CPU 11. The CPU 11 integrally controls the image forming apparatus 100 by executing various control programs stored in the ROM 12 in advance. It is noted that the control portion 6 may be composed of an electronic circuit such as an integrated circuit (ASIC).

### Configuration of Image Forming Portion 2

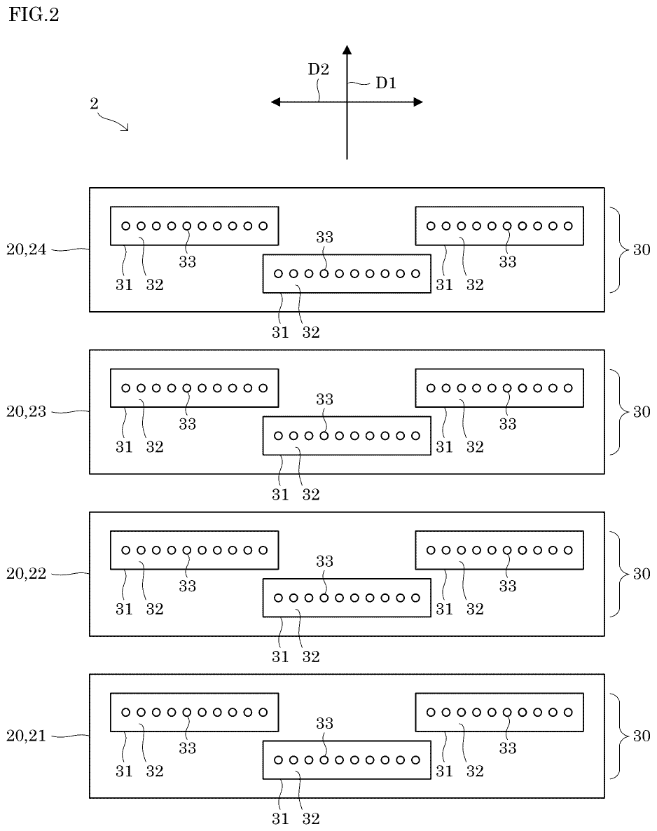

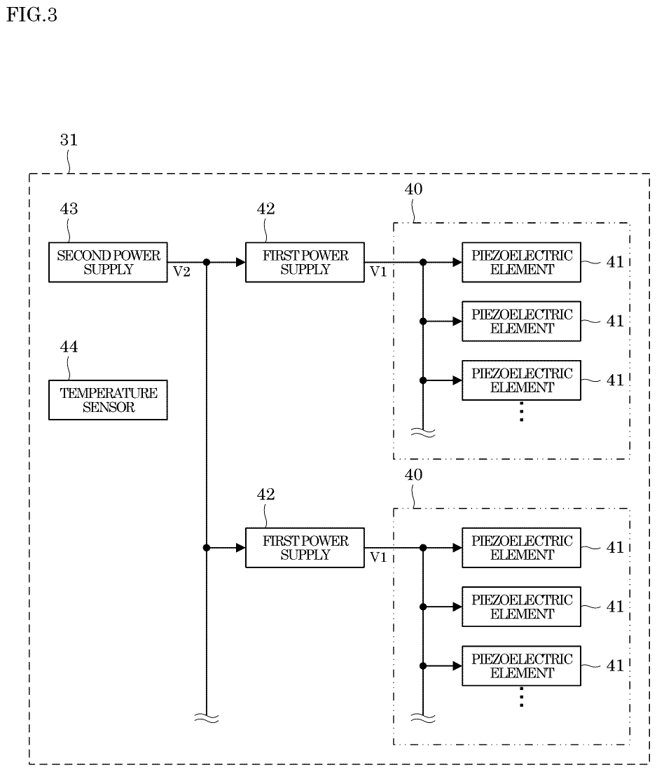

Next, the configuration of the image forming portion 2 will be described with reference to FIGS. 2 and 3. Here, FIG. 2 is a view of a plurality of line heads 20 from a nozzle surface 32 side. In addition, FIG. 3 is a block diagram showing the configuration of a recording head 31. It is noted that FIG. 3 shows the recording head 31 using a dashed line. In addition, FIG. 3 shows blocks 40 each composed of a plurality of piezoelectric elements 41 using two-dot chain lines.

The image forming portion 2 includes the four line heads 20 (21, 22, 23, and 24) (see FIG. 2) corresponding to four printing colors (black, cyan, magenta, and yellow).

The four line heads 20 each form an ink image on a sheet conveyed by the sheet conveying portion 1 in a conveyance direction D1 (see FIG. 2).

As shown in FIG. 2, each of the line heads 20 is long in a width direction D2 (see FIG. 2) orthogonal to the conveyance direction D1 (see FIG. 2). The four line heads 20 are provided side by side at even intervals along the conveyance direction D1.

Of the four line heads 20, the line head 21 disposed the most upstream in the conveyance direction D1 corresponds to the printing color of black. Of the four line heads 20, the line head 22 adjacent to the line head 21 on the downstream side of the line head 21 in the conveyance direction D1 corresponds to the printing color of cyan. Of the four line heads 20, the line head 23 adjacent to the line head 22 on the downstream side of the line head 22 in the conveyance direction D1 corresponds to the printing color of magenta. Of the four line heads 20, the line head 24 disposed the most downstream in the conveyance direction D1 corresponds to the printing color of yellow.

The respective line heads 20 include common components except that the corresponding printing colors are different. The following therefore describes only the components of the line head 21 and omits the description of the components of the other line heads 20.

The line head 21 includes the three recording heads 31 (see FIG. 2). The respective recording heads 31 include common components. It is noted that the number of recording heads 31 included in the line head 20 may be two or less or four or more.

As shown in FIG. 2, each of the recording heads 31 has the nozzle surface 32 having a rectangular shape long in the width direction D2. Each of the recording heads 31 is formed to have the shape of a rectangular column having the nozzle surface 32 as a bottom surface. The three recording heads 31 are disposed in a staggered pattern along the width direction D2.

As shown in FIG. 2, the line head 21 includes a nozzle group 30 (see FIG. 2) including a plurality of nozzles 33. The nozzle group 30 is composed of all the nozzles 33 provided to the line head 21. The plurality of nozzles 33 composing the nozzle group 30 is disposed at even intervals along the width direction D2.

Specifically, the plurality of nozzles 33 composing the nozzle group 30 is distributed and disposed on the three nozzle surfaces 32. For example, each of the nozzle surfaces 32 is provided with a nozzle row formed by the plurality of nozzles 33 arranged at even intervals along the width direction D2. In addition, the three recording heads 31 are disposed in a staggered pattern along the width direction D2 such that the plurality of nozzles 33 composing the nozzle group 30 is disposed at even intervals along the width direction D2. It is noted that a plurality of the nozzle rows may be disposed on each of the nozzle surfaces 32 along the conveyance direction D1.

As shown in FIG. 3, the recording head 31 includes the piezoelectric element 41 corresponding to each of the nozzles 33 disposed on the nozzle surface 32. In addition, as shown in FIG. 3, the recording head 31 includes a plurality of first power supplies 42, a second power supply 43, and a temperature sensor 44.

Each of the piezoelectric elements 41 ejects ink from the nozzle 33 in response to the input of a drive voltage V1 (see FIG. 3) set in advance. The piezoelectric element 41 is an example of an ejection portion according to this disclosure.

Each of the first power supplies 42 is provided to correspond to the block 40 (see FIG. 3) composed of the plurality of piezoelectric elements 41. That is, the recording head 31 includes the plurality of blocks 40 and the plurality of first power supplies 42 corresponding to the plurality of blocks 40.

Each of the first power supplies 42 outputs the drive voltage V1 within the outputtable range corresponding to an input voltage V2 (see FIG. 3) set in advance to each of the piezoelectric elements 41 included in the block 40 in response to the input of the input voltage V2. For example, each of the first power supplies 42 is a linear regulator.

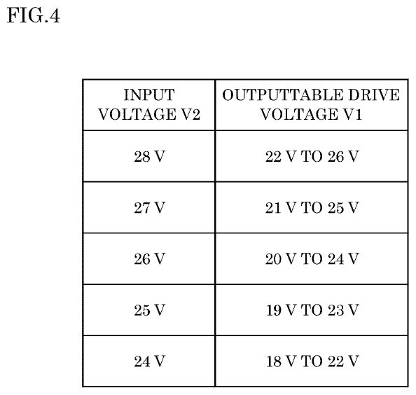

Here, FIG. 4 shows the outputtable ranges of the first power supply 42. As shown in FIG. 4, the first power supply 42 has an outputtable range of 22 V (volts) to 26 V (volts) in a case where the input voltage V2 has a voltage value of 28 V (volts). In addition, the first power supply 42 has an outputtable range of 21 V (volts) to 25 V (volts) in a case where the input voltage V2 has a voltage value of 27 V (volts). In addition, the first power supply 42 has an outputtable range of 20 V (volts) to 24 V (volts) in a case where the input voltage V2 has a voltage value of 26 V (volts). In addition, the first power supply 42 has an outputtable range of 19 V (volts) to 23 V (volts) in a case where the input voltage V2 has a voltage value of 25 V (volts). In addition, the first power supply 42 has an outputtable range of 18 V (volts) to 22 V (volts) in a case where the input voltage V2 has a voltage value of 24 V (volts). That is, the first power supply 42 is capable of outputting the drive voltage V1 within a range having, as an upper limit, a voltage lower than the input voltage V2 by 2 V (volts) and having, as a lower limit, a voltage lower than the upper limit by 4 V (volts). Additionally, it is sufficient if the first power supply 42 is capable of outputting the drive voltage V1 within a range having, as an upper limit, a voltage lower than the input voltage V2 by a first voltage value and having, as a lower limit, a voltage lower than the upper limit by a second voltage value.

The second power supply 43 outputs the input voltage V2 (see FIG. 3) to the plurality of first power supplies 42. For example, each of the second power supplies 43 is a DC-DC converter.

The temperature sensor 44 senses the temperature of the recording head 31.

### Configuration of Control Portion 6

Next, the configuration of the control portion 6 will be described with reference to FIG. 1.

As shown in FIG. 1, the control portion 6 includes a sensing processing portion 51, a first setting processing portion 52, a second setting processing portion 53, an acquisition processing portion 54, a third setting processing portion 55, and a report processing portion 56.

Specifically, the ROM 12 of the control portion 6 stores an operation control program in advance for causing the control portion 6 to function as each of the processing portions described above. The CPU 11 of the control portion 6 functions as each of the processing portions shown in FIG. 1 by executing the operation control program.

It is noted that some or all of the processing portions included in the control portion 6 may be composed of an electronic circuit. In addition, the operation control program may be a program for causing a plurality of processors to function as the respective processing portions shown in FIG. 1.

The sensing processing portion 51 senses the temperature of ink while an image formation process of forming an image on a sheet using the piezoelectric element 41 is in execution.

For example, the sensing processing portion 51 acquires, as the temperature of ink, the temperature of the recording head 31 sensed by the temperature sensor 44.

It is noted that the image forming apparatus 100 may include a sensor capable of directly sensing the temperature of ink. In this case, it is sufficient if the sensing processing portion 51 senses the temperature of ink using the sensor.

The first setting processing portion 52 sets the drive voltage V1 for each of the first power supplies 42 on the basis of a result of sensing by the sensing processing portion 51.

For example, in the image forming apparatus 100, a reference voltage is set in advance for each of the first power supplies 42. The reference voltage is set on the basis of the ink ejection performance of the recording head 31 and the ink ejection performance of the block 40 corresponding to the first power supply 42. The reference voltage corresponding to each of the first power supplies 42 is stored in the storage portion 5.

In addition, in the image forming apparatus 100, table data indicating the relationship between the temperature of ink sensed by the sensing processing portion 51 and a correction value to be used to correct the reference voltage is stored in the storage portion 5 in advance. In the table data, the correction value in a case where the temperature of ink sensed by the sensing processing portion 51 matches reference temperature defined in advance is defined at “0 V (volts)”. In addition, in the table data, the relationship between the temperature of ink sensed by the sensing processing portion 51 and the correction value is defined such that the correction value grows smaller on the minus side as the temperature of ink grows higher than the reference temperature on the high temperature side. For example, the minimum value of the correction value is “−0.5 V (volts)”. In addition, in the table data, the relationship between the temperature of ink sensed by the sensing processing portion 51 and the correction value is defined such that the correction value grows larger on the plus side as the temperature of ink grows lower than the reference temperature on the low temperature side. For example, the maximum value of the correction value is “+0.5 V (volts)”.

In a case where the temperature of ink is sensed by the sensing processing portion 51, the first setting processing portion 52 acquires the correction value corresponding to the sensed temperature of ink using the table data. In addition, the first setting processing portion 52 corrects the reference voltage corresponding to each of the first power supplies 42 by adding the acquired correction value to the reference voltage corresponding to the first power supply 42. The first setting processing portion 52 then sets the corrected reference voltage corresponding to each of the first power supplies 42 as the new drive voltage V1 of the first power supply 42.

For example, the first setting processing portion 52 sets the drive voltage V1 of each of the first power supplies 42 by instructing the first power supply 42 to change the drive voltage V1 to be output.

This adjusts the drive voltage V1 depending on the temperature of ink while the image formation process is in execution.

The second setting processing portion 53 sets the settable range of the drive voltage V1 by the first setting processing portion 52 in response to a setting operation defined in advance. The settable range is set for each of the first power supplies 42.

For example, the second setting processing portion 53 causes the operation display portion 3 to display a setting change screen to be displayed for each of the first power supplies 42 in response to a call operation defined in advance. In the setting change screen, a setting change operation (the setting operation) for the reference voltage corresponding to the first power supply 42 is received. In a case where the setting change operation is received for any of the first power supplies 42 in the setting change screen, the second setting processing portion 53 changes the reference voltage corresponding to the first power supply 42 in accordance with the received setting change operation.

For example, the second setting processing portion 53 rewrites information indicating the reference voltage corresponding to any of the first power supplies 42 stored in the storage portion 5, thereby changing the reference voltage corresponding to the first power supply 42.

For example, the reference voltage corresponding to each of the first power supplies 42 is adjusted in a case where the ink ejection performance of the whole of the recording head 31 is reduced because of the aged deterioration of the recording head 31. In addition, the reference voltages corresponding to the respective first power supplies 42 are adjusted in a case where the respective blocks 40 vary more in ink ejection performance because of the aged deterioration of the recording head 31.

Incidentally, in the image forming apparatus 100, the upper limit value or the lower limit value of the settable range set by the second setting processing portion 53 exceeds or falls below the outputtable range corresponding to the input voltage V2 in some cases. In this case, in a case where the drive voltage V1 exceeding or falling below the outputtable range is set by the first setting processing portion 52, malfunction is caused such as an error bringing the image formation process to a stop or outputting the drive voltage V1 having the upper limit value or the lower limit value of the outputtable range instead of the set drive voltage V1 to decrease the quality of an image formed through the image formation process.

In contrast, the image forming apparatus 100 according to the embodiment of this disclosure is capable of preventing the drive voltage V1 set on the basis of the temperature of ink from exceeding the outputtable range of the first power supply 42 as described below.

The acquisition processing portion 54 acquires the upper limit value and the lower limit value of each of the settable ranges at a specific timing outside an execution period of the image formation process.

For example, the specific timing includes a timing at which the image forming apparatus 100 is powered on.

For example, the acquisition processing portion 54 reads the reference voltage corresponding to each of the first power supplies 42 from the storage portion 5. The acquisition processing portion 54 then acquires the upper limit value of each of the settable ranges by adding the maximum value of the correction value to each of the read reference voltages. In addition, the acquisition processing portion 54 acquires the lower limit value of each of the settable ranges by adding the minimum value of the correction value to each of the read reference voltages.

The third setting processing portion 55 sets the input voltage V2 on the basis of the highest value of the plurality of upper limit values and the lowest value of the plurality of lower limit values acquired by the acquisition processing portion 54 in a case where any one of the highest value and the lowest value is not included in the outputtable range of the first power supply 42.

Specifically, in a case where the difference between the highest value and the lowest value is less than or equal to the difference (4 V (volts)) (see FIG. 4) between the two limit values of the outputtable range of the first power supply 42, the third setting processing portion 55 sets the input voltage V2 such that the highest value and the lowest value are both included in the outputtable range of the first power supply 42.

In addition, in a case where the difference between the highest value and the lowest value is greater than the difference between the two limit values of the outputtable range of the first power supply 42, the third setting processing portion 55 sets the input voltage V2 such that the highest value is included in the outputtable range of the first power supply 42 and the difference between the lowest value and the lower limit value of the outputtable range of first power supply 42 is minimized.

Additionally, in a case where the difference between the highest value and the lowest value is greater than the difference between the two limit values of the outputtable range of the first power supply 42, the third setting processing portion 55 may set the input voltage V2 such that the lowest value is included in the outputtable range of the first power supply 42 and the difference between the highest value and the upper limit value of the outputtable range of first power supply 42 is minimized.

In addition, in a case where the difference between the highest value and the lowest value is greater than the difference between the two limit values of the outputtable range of the first power supply 42, the third setting processing portion 55 may set the input voltage V2 such that none of the highest value and the lowest value are included in the outputtable range of the first power supply 42, and the difference between the highest value and the upper limit value of the outputtable range of the first power supply 42 and the difference between the lowest value and the lower limit value of the outputtable range of the first power supply 42 are equal.

In a case where the difference between the highest value and the lowest value is greater than the difference (4 V (volts)) (see FIG. 4) between the two limit values of the outputtable range of the first power supply 42, the report processing portion 56 reports that the difference between the highest value and the lowest value is greater than the difference between the two limit values of the outputtable range of the first power supply 42.

For example, in a case where the difference between the highest value and the lowest value is greater than the difference between the two limit values of the outputtable range of the first power supply 42, the report processing portion 56 causes the operation display portion 3 to display a message indicating that the difference between the highest value and the lowest value is greater than the difference between the two limit values of the outputtable range of the first power supply 42. This allows a user to recognize in advance that malfunction may be caused because the drive voltage V1 set on the basis of the temperature of ink exceeds the outputtable range of the first power supply 42.

### Drive Voltage Setting Process

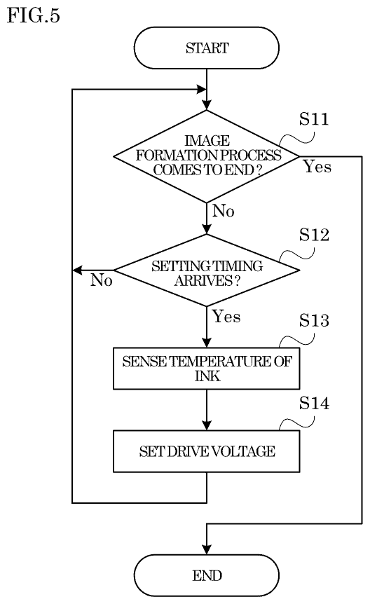

The following describes part of a setting method according to this disclosure along with examples of procedures of a drive voltage setting process that is executed by the control portion 6 in the image forming apparatus 100 with reference to FIG. 5. Here, steps S11, S12, . . . denote the numbers of processing procedures (steps) that are executed by the control portion 6. Additionally, in a case where the image formation process is executed, the drive voltage setting process is executed along with the image formation process. In addition, the drive voltage setting process is executed for each of the recording heads 31.

### Step S11

First, in step S11, the control portion 6 determines whether or not the image formation process comes to an end.

Here, when the control portion 6 determines that the image formation process comes to an end (Yes in S11), the control portion 6 brings the drive voltage setting process to an end. In addition, if the image formation process has not yet come to an end (No in S11), the control portion 6 shifts the process to step S12.

### Step S12

In step S12, the control portion 6 determines whether or not a setting timing of the drive voltage V1 arrives. Here, the setting timing is, for example, a timing that periodically arrives while the image formation process is in execution.

Here, when the control portion 6 determines that the setting timing arrives (Yes in S12), the control portion 6 shifts the process to step S13. In addition, if the setting timing has not yet arrived (No in S12), the control portion 6 shifts the process to step S11.

### Step S13

In step S13, the control portion 6 senses the temperature of ink. The process of step S13 is an example of a sensing step according to this disclosure and is executed by the sensing processing portion 51 of the control portion 6.

Specifically, the control portion 6 acquires, as the temperature of ink, the temperature of the recording head 31 sensed by the temperature sensor 44.

### Step S14

In step S14, the control portion 6 sets the drive voltage V1 for each of the first power supplies 42 on the basis of a result of sensing through the process of step S13. The process of step S14 is an example of a first setting step according to this disclosure and is executed by the first setting processing portion 52 of the control portion 6.

Specifically, the control portion 6 acquires the correction value corresponding to the sensed temperature of ink using the table data. In addition, the control portion 6 corrects the reference voltage corresponding to each of the first power supplies 42 by adding the acquired correction value to the reference voltage corresponding to the first power supply 42. The control portion 6 then sets the corrected reference voltage corresponding to each of the first power supplies 42 as the new drive voltage V1 of the first power supply 42.

Here, in the image forming apparatus 100, the settable range of each of the drive voltages V1 is changed at any timing outside an execution period of the image formation process. The process of changing the settable range of each of the drive voltages V1 is an example of a second setting step according to this disclosure and is executed by the second setting processing portion 53 of the control portion 6.

### Input Voltage Setting Process

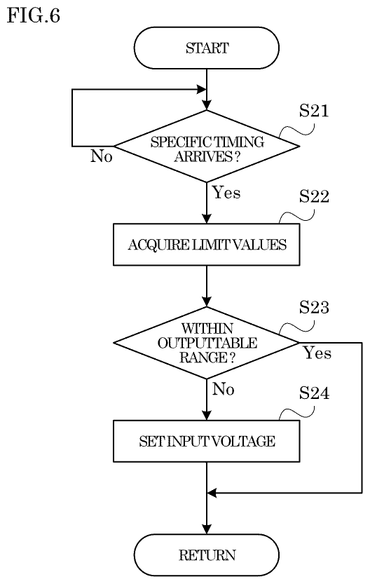

Next, the remaining part of the setting method according to this disclosure will be described along with examples of procedures of an input voltage setting process that is executed by the control portion 6 in the image forming apparatus 100 with reference to FIG. 6. It is noted that the input voltage setting process is executed for each of the recording heads 31.

### Step S21

First, in Step S21, the Control Portion 6 Determines Whether or Not the Specific timing arrives.

Here, when the control portion 6 determines that the specific timing arrives (Yes in S21), the control portion 6 shifts the process to step S22. In addition, if the specific timing has not yet arrived (No in S21), the control portion 6 waits for the arrival of the specific timing in step S21.

### Step S22

In step S22, the control portion 6 acquires the upper limit value and the lower limit value of each of the settable ranges. The process of step S22 is an example of an acquisition step according to this disclosure and is executed by the acquisition processing portion 54 of the control portion 6.

For example, the control portion 6 reads the reference voltage corresponding to each of the first power supplies 42 from the storage portion 5. The control portion 6 then acquires the upper limit value of each of the settable ranges by adding the maximum value of the correction value to each of the read reference voltages. In addition, the control portion 6 acquires the lower limit value of each of the settable ranges by adding the minimum value of the correction value to each of the read reference voltages.

### Step S23

In step S23, the control portion 6 determines whether or not the highest value of a plurality of upper limit values and the lowest value of a plurality of lower limit values acquired through the process of step S22 are both included in the outputtable range of the first power supply 42 corresponding to the current input voltage V2.

Here, when the control portion 6 determines that the highest value and the lowest value are both included in the outputtable range of the first power supply 42 corresponding to the current input voltage V2 (Yes in S23), the control portion 6 shifts the process to step S21. In addition, if any one or both of the highest value and the lowest value are not included in the outputtable range of the first power supply 42 corresponding to the current input voltage V2 (No in S23), the control portion 6 shifts the process to step S24.

### Step S24

In step S24, the control portion 6 sets the input voltage V2 on the basis of the highest value and the lowest value. The process of step S24 is an example of a third setting step according to this disclosure and is executed by the third setting processing portion 55 of the control portion 6.

Specifically, in a case where the difference between the highest value and the lowest value is less than or equal to the difference (4 V (volts)) (see FIG. 4) between the two limit values of the outputtable range of the first power supply 42, the control portion 6 sets the input voltage V2 such that the highest value and the lowest value are both included in the outputtable range of the first power supply 42.

In addition, in a case where the difference between the highest value and the lowest value is greater than the difference between the two limit values of the outputtable range of the first power supply 42, the control portion 6 sets the input voltage V2 such that the highest value is included in the outputtable range of the first power supply 42 and the difference between the lowest value and the lower limit value of the outputtable range of first power supply 42 is minimized.

In this way, in the image forming apparatus 100, the upper limit value and the lower limit value of each of the settable ranges are acquired at the specific timing outside an execution period of the image formation process. The input voltage V2 is then set on the basis of the highest value of the plurality of acquired upper limit values and the lowest value of the plurality of acquired lower limit values in a case where any one of the highest value and the lowest value is not included in the outputtable range of the first power supply 42. This makes it possible to prevent the drive voltage V1 set on the basis of the temperature of ink from exceeding the outputtable range of the first power supply 42.

It is noted that the specific timing may be a timing at which the settable range is set by the second setting processing portion 53. In addition, the specific timing is a timing at which an operation defined in advance is received by the operation display portion 3.

In addition, the second setting processing portion 53 may set (change) any one or both of the maximum value of the correction value and the minimum value of the correction value in response to an operation of a user.

In addition, the recording head 31 may include the first power supply 42 corresponding to each of the piezoelectric elements 41.

In addition, the recording head 31 may include the one first power supply 42 corresponding to all the piezoelectric elements 41 included in the recording head 31.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

An image forming apparatus including:
an ejection portion configured to eject ink from a nozzle in response to an input of a drive voltage set in advance;
a first power supply configured to output the drive voltage within an outputtable range to the ejection portion in response to an input of an input voltage set in advance, the outputtable range corresponding to the input voltage;
a sensing processing portion configured to sense temperature of the ink while an image formation process of forming an image on a sheet using the ejection portion is in execution;
a first setting processing portion configured to set the drive voltage on the basis of a result of sensing by the sensing processing portion;
a second setting processing portion configured to set a settable range of the drive voltage by the first setting processing portion in response to a setting operation defined in advance;
an acquisition processing portion configured to acquire an upper limit value and a lower limit value of the settable range at a specific timing outside an execution period of the image formation process; and
a third setting processing portion configured to set the input voltage on the basis of the upper limit value and the lower limit value acquired by the acquisition processing portion in a case where any one of the upper limit value and the lower limit value is not included in the outputtable range.

### Supplementary Note 2

The image forming apparatus according to Supplementary Note 1, including a second power supply configured to output the input voltage to a plurality of the first power supplies, in which
the settable range is set for each of the first power supplies,
the first setting processing portion sets the drive voltage for each of the first power supplies on the basis of the result of the sensing by the sensing processing portion,
the acquisition processing portion acquires the upper limit value and the lower limit value of each of the settable ranges at the specific timing, and
in a case where any one of a highest value of a plurality of the upper limit values and a lowest value of a plurality of the lower limit values acquired by the acquisition processing portion is not included in the outputtable range, the third setting processing portion sets the input voltage on the basis of the highest value and the lowest value.

### Supplementary Note 3

The image forming apparatus according to Supplementary Note 1 or 2, in which the specific timing includes a timing at which the image forming apparatus is powered on.

### Supplementary Note 4

The image forming apparatus according to any of Supplementary Notes 1 to 3, in which the specific timing includes a timing at which the settable range is set by the second setting processing portion.

### Supplementary Note 5

The image forming apparatus according to any of Supplementary Notes 1 to 4, including a report processing portion configured to report that a difference between the upper limit value and the lower limit value is greater than a difference between two limit values of the outputtable range in a case where the difference between the upper limit value and the lower limit value is greater than the difference between the two limit values of the outputtable range.

### Supplementary Note 6

A setting method that is executed by an image forming apparatus including an ejection portion configured to eject ink from a nozzle in response to an input of a drive voltage set in advance, and a first power supply configured to output the drive voltage within an outputtable range to the ejection portion in response to an input of an input voltage set in advance, the outputtable range corresponding to the input voltage, the setting method including:
a sensing step of sensing temperature of the ink while an image formation process of forming an image on a sheet using the ejection portion is in execution;
a first setting step of setting the drive voltage on the basis of a result of sensing by the sensing step;
a second setting step of setting a settable range of the drive voltage by the first setting step in response to a setting operation defined in advance;
an acquisition step of acquiring an upper limit value and a lower limit value of the settable range at a specific timing outside an execution period of the image formation process; and
a third setting step of setting the input voltage on the basis of the upper limit value and the lower limit value acquired by the acquisition step in a case where any one of the upper limit value and the lower limit value is not included in the outputtable range.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an ejection portion configured to eject ink from a nozzle in response to an input of a drive voltage set in advance;
a first power supply configured to output the drive voltage within an outputtable range to the ejection portion in response to an input of an input voltage set in advance, the outputtable range corresponding to the input voltage;
a sensing processing portion configured to sense temperature of the ink while an image formation process of forming an image on a sheet using the ejection portion is in execution;
a first setting processing portion configured to set the drive voltage on a basis of a result of sensing by the sensing processing portion;
a second setting processing portion configured to set a settable range of the drive voltage by the first setting processing portion in response to a setting operation defined in advance;
an acquisition processing portion configured to acquire an upper limit value and a lower limit value of the settable range at a specific timing outside an execution period of the image formation process; and
a third setting processing portion configured to set the input voltage on a basis of the upper limit value and the lower limit value acquired by the acquisition processing portion in a case where any one of the upper limit value and the lower limit value is not included in the outputtable range.

2. The image forming apparatus according to claim 1, comprising a second power supply configured to output the input voltage to a plurality of the first power supplies, wherein
the settable range is set for each of the first power supplies,
the first setting processing portion sets the drive voltage for each of the first power supplies on the basis of the result of the sensing by the sensing processing portion,
the acquisition processing portion acquires the upper limit value and the lower limit value of each of the settable ranges at the specific timing, and
in a case where any one of a highest value of a plurality of the upper limit values and a lowest value of a plurality of the lower limit values acquired by the acquisition processing portion is not included in the outputtable range, the third setting processing portion sets the input voltage on a basis of the highest value and the lowest value.

3. The image forming apparatus according to claim 1, wherein the specific timing includes a timing at which the image forming apparatus is powered on.

4. The image forming apparatus according to claim 1, wherein the specific timing includes a timing at which the settable range is set by the second setting processing portion.

5. The image forming apparatus according to claim 1, comprising a report processing portion configured to report that a difference between the upper limit value and the lower limit value is greater than a difference between two limit values of the outputtable range in a case where the difference between the upper limit value and the lower limit value is greater than the difference between the two limit values of the outputtable range.

6. A setting method that is executed by an image forming apparatus including an ejection portion configured to eject ink from a nozzle in response to an input of a drive voltage set in advance, and a first power supply configured to output the drive voltage within an outputtable range to the ejection portion in response to an input of an input voltage set in advance, the outputtable range corresponding to the input voltage, the setting method comprising:
a sensing step of sensing temperature of the ink while an image formation process of forming an image on a sheet using the ejection portion is in execution;
a first setting step of setting the drive voltage on a basis of a result of sensing by the sensing step;
a second setting step of setting a settable range of the drive voltage by the first setting step in response to a setting operation defined in advance;
an acquisition step of acquiring an upper limit value and a lower limit value of the settable range at a specific timing outside an execution period of the image formation process; and
a third setting step of setting the input voltage on a basis of the upper limit value and the lower limit value acquired by the acquisition step in a case where any one of the upper limit value and the lower limit value is not included in the outputtable range.
